(19) United States
(12) Patent Application Publication
(10) Pub. No.: US 2011/0045294 A1
(43) Pub. Date: Feb. 24, 2011

(54) Data and/or Power Transmission Cable With a Fireproofed Coating, and a Method for Fireproofing Such a Coating

(76) Inventors: Jérô me Fournier, Lyon (FR); Gilles Widawski, Saint Cyr Au Mont D'or (FR)

Correspondence Address: SOFER & HAROUN LLP., 317 MADISON AVENUE, SUITE 910, NEW YORK, NY, 10017, US

(21) Appl. No.: 11/992,807

(22) PCT Filed: Sep. 29, 2006
(86) PCT No.: PCT/FR2006/050967

§ 371 Date: Nov. 15, 2010

(30) Foreign Application Priority Data
Oct. 3, 2005 (FR) 0552994

(51) Int. Cl. B32B 1/00; B05D 5/12

(52) U.S. Cl. 428/375; 427/126.3; 427/120

(57) ABSTRACT

The invention concerns a method for fireproofing a coating of a data and/or power transmitting cable by incorporating at least one fire-retardant agent in said coating. The invention is characterized in that said incorporation is performed after the manufacture of said coating and is carried out using a supercritical fluid.

The present invention relates to a data and/or power transmission cable having a fireproofed coating, and to a method of fireproofing a coating of a data and/or power transmission cable.

In known manner, in the event of a fire acquirers of electrical and/or optical cables, for transporting power and/or transmitting information desire to avoid flames propagating along the cable, even when laid vertically, and to prevent the insulating material and/or the sheath covering the core of the cable from dripping.

To improve the fire-endurance properties of cables, a first conventional method consists in applying fireproofing (intumescent) paint to the cable after it has been installed. In that method, the treatment remains superficial, with penetration depth being small, and it does not enable the coating to be fireproofed to its core.

In addition, filled compositions present high viscosity, they are often difficult to work, and the organic solvents used are expensive and polluting.

A second conventional method consists in incorporating halogenated or non-halogenated fire-retardant agents in the insulating material during fabrication of the cable, usually at the moment when the polymeric composition used for obtaining the insulation material is still liquid.

That incorporation technique does not make it possible to control the way such fire-retardant agents are distributed, such that neither the fireproofing nor the mechanical properties of the cable are satisfactory below a certain concentration of filler. For the degree of fireproofing to be satisfactory, it is thus necessary to incorporate filler at concentrations of about 60%, which diminishes mechanical properties.

In addition, since the working temperature for fabricating cables is often greater than 160° C., fireproofing agents presenting poor ability to withstand high temperatures cannot be used. For example, aluminum hydroxide begins to degrade from 200° C., thereby limiting the range of temperatures that can be used in fabrication. Magnesium hydroxide can be used at temperatures that are higher, but because of the greater increase in the viscosity of the mixture, fabrication speed is limited.

The invention seeks to provide a method of incorporating at least one fire-retardant agent in a cable coating, which method leads to a better control over the distribution of fire-retardant agent(s) in the coating, and is preferably inexpensive, being optimized in terms of efficiency and without impact on the environment.

For this purpose, the invention proposes a method of incorporating at least one fire-retardant agent in a data and/or power transmission coating, which method is characterized in that said incorporation is performed after said coating has been fabricated and is performed by means of a supercritical fluid.

Supercritical fluid technology makes it possible to impart or improve fire-endurance properties to any cable coating after it has been fabricated, in sheath and/or insulating material and prior to the cable being installed.

Said incorporation is performed in a closed circuit, e.g. in an autoclave, so very little escapes to the atmosphere.

Advantageously, the supercritical fluid may be carbon dioxide (CO₂).

In a preferred implementation, the fire-retardant agent can be selected from at least one of the following non-halogenated compounds: metallic hydroxides; metallic hydroxycarbonates; silica; phylosilicates; zinc hydroxystannates and zinc stannates; phosphorous derivatives; and boron compounds.

Amongst metallic hydroxides, mention can be made of magnesium hydroxide, aluminum trihydrate, hydromagnesite, calcium hydroxide, and magnesium citrate. Metallic hydroxides are natural or synthesized, with or without surface treatment, and with differing grain sizes.

Amongst metallic hydrocarbonates, mention can be made of calcium carbonate and of magnesium carbonate.

These agents can be used on their own or in combination as a function of the materials degradation temperatures and the fire endurance that it is desired to obtain.

Phosphorous derivatives improve ability of materials to withstand fire by forming a protective charred layer.

Similarly, boron compounds such as metallic borates (e.g. zinc borate, calcium borate) are effective fire-retardants.

Boron compounds can have a synergy effect if they are used in combination with metallic hydroxides. Inorganic compounds such as metallic hydroxides decompose endothermally, releasing molecules of water, thereby having the consequence of lowering the temperature of the material and thus slowing its rate of degradation.

In another preferred implementation, said fire-retardant agent may be selected from at least one of the following halogenated compounds: halogenated compounds based on chlorine and halogenated compounds based on bromine.

In a preferred implementation, an incorporation temperature of less than 160° C. is selected.

In this configuration, the energy consumption needed for heating the treatment bath is particularly low.

The incorporation temperature is selected to be very low so as to adapt to the poor high temperature behavior of hydrates, such as citrates for example, that decompose at temperatures of 160° C.

The fireproofing method may comprise the following operations:

maintaining the fluid in the supercritical state for a predetermined duration to obtain incorporation in the coating;

eliminating the supercritical fluid; and

recovering the cable with the fireproofed coating.

Another object of the invention is to develop a cable having a coating that is both fireproof and that has good mechanical properties, which cable is preferably inexpensive, and can be fabricated easily and quickly.

For this purpose, the invention provides a data and/or power transmission cable including a fireproof coating made of a material incorporating at least one fire-retardant agent, the cable being characterized in that said coating presents a concentration gradient such that the concentration of said at least one fire-retardant agent at the outside surface of said coating is greater than the concentration of said at least one fire-retardant agent at the inside surface of said coating.

The term “outside surface” is defined as the surface of the coating that is farther from the axis of said cable.

In contrast, the term “inside surface” corresponds to the surface of the coating that is closer to the axis of said cable.

In this way, the coating of the invention presents fire-withstanding properties because of a high concentration of fire-retardant agent at its surface and strengthened mechanical properties because of the reduction in concentration through its volume.

In a first embodiment, said fire-retardant agent may be selected from at least one of the following non-halogenated compounds: metallic hydroxides; metallic hydroxycarbonates; silica; phylosilicates; zinc hydroxystannates and zinc stannates; phosphorous derivatives; and boron compounds.

In another embodiment, it may be selected from halogenated compounds based on chlorine or based on bromine, such as polybromodiphenyls and polybromodiphenylethers.

The features and advantages of the invention appear clearly on reading the following description of illustrative and non-limiting examples given with reference to the accompanying figures, in which:

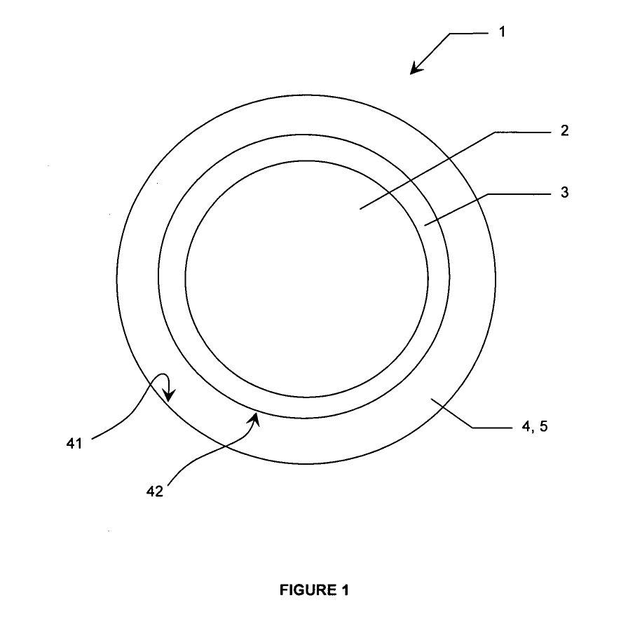

FIG. 1 is a diagrammatic cross-section view of a power transmission cable of the invention, in a preferred embodiment of the invention; and

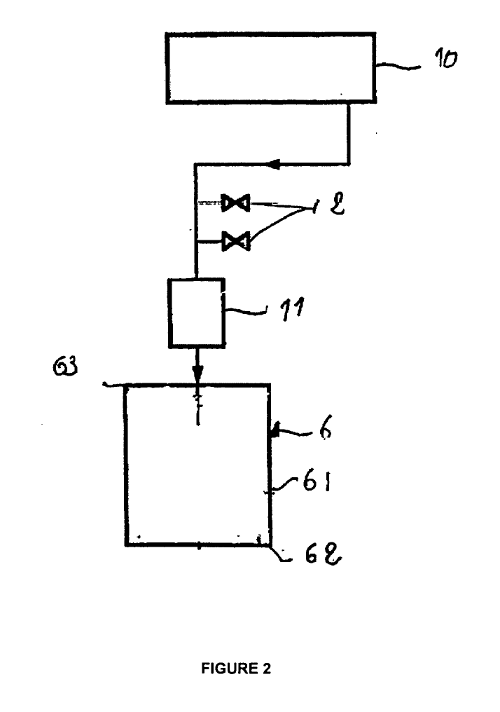

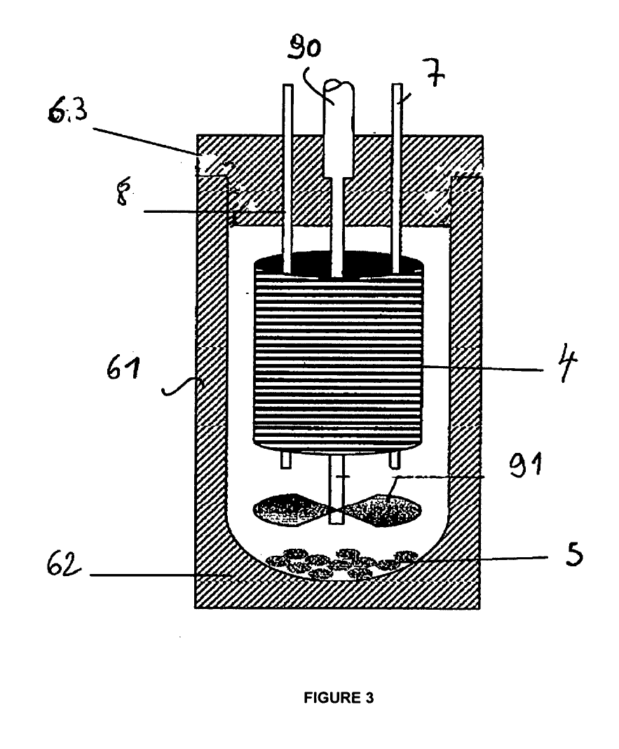

FIGS. 2 and 3 are diagrams showing the device for implementing the method of the invention for fireproofing a coating of an energy or data transmission cable by incorporating at least one fire-retardant agent in the coating.

FIG. 1 is a cross-section of a power transmission cable 1 comprising, for example: a transmission element 2 such as an electrical conductor, e.g. made of copper, coated in a sheath 3, itself coated in a coating 4 of insulating material, e.g. a polymer of the polyethylene type incorporating fire-retardant agents 5, preferably a mixture of a boron compound with a metallic citrate.

Said coating 4 has an inside surface 42 in contact with said sheath 3, and an outside surface 41, said outside surface 41 being further away from the axis of the electrical conductor 2 than said inside surface 42.

In accordance with the objects of the invention, the concentration of fire-retardant agents 5 is greater at the periphery or outside surface 41 of the coating 4 than it is at the inside surface 42 of the coating 4.

For example, said concentration at the outside surface of said coating may be 40% by weight of filler relative to the total composition of said coating, i.e. 0.80 grams (g) of fire-retardant agent per cubic centimeter (cm³) of coating at the periphery, with said concentration decreasing gradually so as to reach in the core of said coating 10% by weight of filler relative to the total composition of said coating, i.e. 0.20 g of fire-retardant agent per cm³ of coating in the core, and then reaching at the inside surface of said coating, a concentration of 0% by weight of filler relative to the total composition of said coating.

More generally, the invention applies equally well to power transmission cables and to telecommunications cables, to data cables, electric cables, or optical fiber cables.

The method of the invention relates to fireproofing a coating of a power or data cable by incorporating at least one fire-retardant agent in the coating by means of a supercritical fluid. The material of the coating is an insulating material and/or a sheathing material. The supercritical fluid, preferably CO₂, is used as a vector solvent for incorporating fire-retardant agent(s) in the coating. It advantageously replaces the non-aqueous organic solvents used after the cable has been installed in conventional impregnation treatments and that often require expensive reprocessing.

The supercritical state combines the molecular density of a liquid with the molecular mobility of a gas, two parameters that are essential in reaction mechanisms at interfaces. In addition, since the surface tension of a supercritical fluid is negligible, it can penetrate that much more easily into a polymer material.

The supercritical fluid technique makes it possible to achieve the fireproofing property optimization taught by the invention by means of a concentration gradient in fire-retardant agent(s). The temperature and pressure conditions of the fluid in the supercritical state depend on the critical point of the fluid and on the nature of the coating material and on the fire-retardant agent(s) selected for incorporation.

The dissolving power of the supercritical fluid depends mainly on its physical state described by its pressure, its temperature, and its density, and on its chemical nature, in particular its polarizability. When the density of the supercritical fluid increases, the mean intermolecular distances decrease, thus encouraging specific interactions between the solvent and the fire-retardant agent(s).

The duration of the treatment depends on the temperature and pressure conditions of the fluid in the supercritical state, on the nature of the coating material, and on the fire-retardant agent(s) selected for incorporation, and also on the quantity and the gradient desired at depth.

At constant temperature, the density of a supercritical fluid increases with pressure. For given pressure, an increase in temperature will lead to an increase in the vapor pressure of the fire-retardant agent, and thus in its volatility. Simultaneously, that will lead to a reduction in the density of the solvent, and thus to a reduction in its dissolving power. There are thus two competing effects concerning solubility. At low pressure, solubility decreases with increasing temperature, but the effect is reversed at high pressures.

It is advantageous to work at high pressures and at temperatures that are relatively low.

This also makes it possible to make effective use of the quantity of fire-retardant agent since it is possible to perform the method until the quantity introduced into the reactor has been used up, consequential avoiding losses and wastage. Efficiency is at a maximum and in any event the remaining fire-retardant agent that has not been incorporated can be recovered easily.

FIGS. 2 and 3 are diagrams of the apparatus for implementing the method of the invention for fireproofing a power or data cable coating by incorporating at least one fire-retardant agent in the coating by means of a supercritical fluid.

The apparatus comprises a source 10 of CO₂ connected to a pump 11, itself connected to a tubular reactor 6 such as an autoclave with adjustable temperature and pressure.

Valves 12 enable the source 10 to be isolated from the pump 11 and from the reactor 6.

The reactor 6 comprises a tubular body 61, a bottom 62, and a cover 63 provided with means for inserting CO₂ (not shown) and connected to the pump 11.

As can be seen in FIG. 3, the cover 63 is arranged to pass a temperature probe 7, a pressure probe 8, and a drive system 90 for driving a stirrer 91 disposed close to the bottom 62.

Inside the tubular body 61 there is placed an energy or data cable provided with an outer coating 4 to be fireproofed, and at least one fire-retardant agent 5 for incorporation in the coating is placed on the bottom 62.

The fire-retardant agent 5 is preferably selected from the following non-halogenated compounds: metallic hydroxides; metallic hydroxycarbonates; silica; phylosilicates; zinc hydroxystannates and zinc stannates; phosphorous derivatives; and boron compounds.

In a variant, the reactor contains two fire-retardant agents, the first agent being a boron compound and the second agent being one of the following inorganic compounds: metallic hydrates; metallic hydroxides; and preferably metallic citrates.

In operation, the CO₂ is inserted into the reactor from the source 10.

CO₂ turns out to be a supercritical fluid that is particularly advantageous because of its critical parameters (critical temperature equal to 31° C. and critical pressure equal to 73 bars).

The properties of supercritical CO₂ for dissolving chemical species can be modulated. Supercritical CO₂ is the least expensive of the organic solvents that are commercially available, it is non-toxic, it has no impact on the environment, and it is inert relative to polymer type materials.

CO₂ can also be purified merely by decompressing the reactor.

The CO₂ is taken to and maintained in the selected supercritical conditions, preferably a temperature of less than 165° C., e.g. equal to about 100° C., for a pressure selected for example to be equal to about 7.38 megapascals (MPa), and it presents a density of 0.132 grams per cubic centimeter (g/cm³).

The viscosity of CO₂ is about 10⁻⁷ pascal seconds (Pa.s). Mass transfer is encouraged by its low viscosity.

For incorporation purposes, the CO₂ is eliminated from the reactor and from the coating 4 by bringing the pressure and the temperature to ambient pressure and temperature and allowing the CO₂ to escape from the coating under such conditions. A cable is thus obtained that has its coating fireproofed, e.g. a cable as shown in FIG. 1.

### COMPARATIVE EXAMPLE

Three cable samples were prepared for comparing their performance in terms of withstanding fire. The samples in question were all suitable for being used as power and/or telecommunications cables.

Each of the three samples comprised a copper conductor having a diameter of one millimeter, covered in an insulating sheath of polyethylene with a thickness of 500 micrometers, and a coating having a thickness of one millimeter.

The polymer constituting the insulating sheath was common to all three samples. Specifically it was made of a polyethylene.

The coatings of the three samples had different compositions:

the coating of sample 1 was a compound of 100% by weight of ethylene and vinyl acetate (EVA) copolymer and did not include any fire-retardant agent;

the coating of sample 2 was a uniform mixture made up of 50% by weight (relative to the total composition) of ethylene and vinyl acetate (EVA) copolymer and 50% by weight (relative to the total composition) of magnesium hydroxide. The material of the coating was prepared by mixing 500 g of ethylene and vinyl acetate (EVA) copolymer containing 28% by weight of vinyl acetate, a product sold under the trademark Evatane 28-03 by the supplier Arkema, with 500 g of magnesium hydroxide as sold by the supplier Albemarle under the name Magnifin H10. Mixing was performed in a cylinder mixer at a temperature of 160° C., at a speed of rotation of 30 revolutions per minute, and for a duration of 20 minutes; and

the coating of sample 3 was initially constituted by 100% of ethylene and vinyl acetate (EVA) copolymer. Sample 3 was then positioned in an autoclave in the presence of 500 g of magnesium hydroxide as sold by the supplier Albemarle under the name Magnifin H10, in order to be subjected to supercritical CO₂ treatment. That operation was performed in application of the method described above. In the autoclave, the CO₂ was taken to supercritical conditions at a temperature of 100° C. and a pressure of 7.38 MPa, which conditions were maintained for about two hours. At the end of the treatment, the CO₂ was eliminated from the reactor by bringing the pressure and the temperature to ambient pressure and temperature and allowing the CO₂ to escape under those conditions. After the treatment, the coating of sample 3 was constituted by a non-uniform mixture comprising the ethylene and vinyl acetate (EVA) copolymer and magnesium hydroxide, with the concentration of fire-retardant agent (magnesium hydroxide) being greater at the outside surface of the coating. The magnesium hydroxide concentration inside said coating was evaluated at 65% by weight (relative to the total composition) at the outside surface of the coating, and at 0% at its inside surface.

Fire behavior was evaluated for all three examples in compliance with the IEC 60332-1 standard. Table 1 summarizes the fire performance obtained with each of the three samples. Each test had a maximum duration of 10 minutes and served to evaluate propagation time, which ought to be as long as possible.

TABLE 1

| Sample | Propagation time (s) |
|---|---|
| 1 | 205 |
| 2 | 410 |
| 3 | 560 |

Firstly it should be observed that sample 2 provides better performance than reference sample 1. Propagation time was lengthened by 205 seconds. That result is not surprising since the coating of sample 2 contained a flame-retardant agent, while the coating of sample 1 did not contain any.

Sample 3 can be compared with sample 2 since both of them had coatings containing the same fireproofing filler. It can be seen that the propagation time of sample 3 was lengthened by 150 seconds relative to sample 2. The use of treatment by supercritical CO₂ thus led to a concentration of fire-retardant agent that was greater at the outside surface of the coating and enabled a greater improvement in propagation time to be achieved.

1. A method of fireproofing a data and/or power transmission cable coating by incorporating at least one fire-retardant agent in said coating, said method said method comprising the steps of:
incorporating said at least one fire-retardant after said coating has been fabricated, where said incorporation is performed by means of a supercritical fluid.

2. A method according to claim 1 for fireproofing a cable coating, wherein the supercritical fluid is carbon dioxide.

3. A method according to claim 1 for fireproofing a cable coating, wherein said at least one fire-retardant agent is selected from at least one of the following group of non-halogenated compounds: metallic hydroxides; metallic hydroxycarbonates; silica; phylosilicates; zinc hydroxystannates and zinc stannates; phosphorous derivatives; and boron compounds.

4. A method according to claim 1 for fireproofing a cable coating, wherein said at least one fire-retardant agent is selected from at least one of the following groups of halogenated compounds: chlorine-based halogenated compounds and bromine-based halogenated compounds.

5. A method according to any one of claim 1 for fireproofing a cable coating, wherein the incorporation temperature is less than 160° C.

6. A method according to claim 1 for fireproofing a cable coating, further comprising the steps of:
maintaining the fluid in the supercritical state for a predetermined duration to obtain incorporation in the coating;
eliminating the supercritical fluid; and
recovering the cable with the fireproofed coating.

7. A data and/or power transmission cable comprising:
a fireproof coating made of a material incorporating at least one fire-retardant agent, wherein said coating presents a concentration gradient such that the concentration of said at least one fire-retardant agent at the outside surface of said coating is greater than the concentration of said at least one fire-retardant agent at the inside surface of said coating.

8. A data and/or power transmission cable according to claim 7, wherein said at least one fire-retardant agent is selected from at least one of the following group of non-halogenated compounds: metallic hydroxides; metallic hydroxycarbonates; silica; phylosilicates; zinc hydroxystannates and zinc stannates; phosphorous derivatives; and boron compounds.

9. A data and/or power transmission cable according to claim 7, wherein said at least one fire-retardant agent is selected from the group of halogenated compounds based on chlorine or based on bromine.
